(19) United States
(12) Patent Application Publication
(10) Pub. No.: US 2026/0045427 A1
(43) Pub. Date: Feb. 12, 2026

(54) Elastic Piece Trigger Photoelectric Conduction Mechanism Applied to Key Switch

(71) Applicant: DONGGUAN CITY KAIHUA ELECTRONICS CO.LTD, Dongguan, Guangdong (CN)

(72) Inventors: Fuxi WU, Dongguan, Guangdong (CN); Panhao LV, Dongguan, Guangdong (CN)

(21) Appl. No.: 18/995,806

(22) PCT Filed: Dec. 4, 2023
(86) PCT No.: PCT/CN2023/136104

§ 371 Date: Jan. 16, 2025

(30) Foreign Application Priority Data
Dec. 13, 2022 (CN) 202223338093.8

(51) Int. Cl. H01H 13/02; H01H 13/14; H01H 13/52

(52) U.S. Cl. CPC H01H 13/023; H01H 13/14; H01H 13/52

(57) ABSTRACT

An elastic piece trigger type photoelectric conduction mechanism applied to a button switch, comprising a base (1), a balance frame assembly (2) provided on the base, and a light-emitting pair tube (3) electrically connected to a PCB (4), wherein the balance frame assembly comprises a first balance bar (21) rotatably connected to the base, a second balance bar (22) rotatably connected to the base. The elastic piece trigger type photoelectric conduction mechanism endows the balance frame assembly with the function of triggering on/off of the button switch, such that a stable pressing action is synchronized with an on-off action of an optical path, thereby realizing the synchronization of the stable pressing action and an on-off action of the button switch, improving the accuracy and sensitivity of the on/off action of the button switch, and achieving long service life.

### TECHNICAL FIELD

The utility model relates to the field of key switches, in particular to an elastic piece trigger photoelectric conduction mechanism applied to key switches.

### TECHNICAL BACKGROUND

In the existing key switch, in order to improve the pressing balance, a balance frame structure is usually added inside the key switch, so that when the key cap on the key switch is pressed at any position, it can move down smoothly, thus improving the pressing balance.

However, the existing balance frame structure only plays the role of balance pressing and has a single function.

At the same time, due to the limitation of internal conduction structure design, the accuracy and sensitivity of conduction and disconnection actions are low.

### SUMMARY OF UTILITY MODEL

In view of the above shortcomings, the utility model aims to provide an elastic piece-triggered photoelectric on-off mechanism applied to key switches, which endows the balance frame assembly with the function of triggering the on-off of key switches, so that the smooth pressing action is synchronized with the on-off action of optical paths, thereby realizing the synchronization of the smooth pressing and the on-off action of key switches, improving the accuracy and sensitivity of the on-off action of key switches, and having long service life.

The technical scheme adopted by the utility model is as follows:

The invention relates to an elastic piece triggered photoelectric conduction mechanism applied to a key switch, which comprises a base, a balance frame component arranged on the base, and a light-emitting diode electrically connected to a PCB board. Wherein, the balance frame assembly comprises a first balance bar rotatably connected to the base, a second balance bar rotatably connected to the base, and an elastic piece connected between the first balance bar and the second balance bar, and the light-emitting pair tube comprises a light-emitting element and a light-sensitive element electrically connected to the PCB board respectively, and is characterized in that a light-shielding piece for shielding light between the light-emitting element and the light-sensitive element is arranged on the elastic piece.

As a further improvement of the utility model, the shading piece is a shading sleeve wrapped around the elastic piece.

As a further improvement of the utility model, a first accommodating cavity and a second accommodating cavity are respectively formed on the lower end face of the base, and the light emitting element is embedded in the first accommodating cavity and the photosensitive element is embedded in the second accommodating cavity.

As a further improvement of the utility model, a light channel which is respectively communicated with the first accommodating cavity and the second accommodating cavity is formed on the base; A movable groove for the shade to move up and down and extend to the light channel is formed on the base.

As a further improvement of the utility model, the elastic piece is a tension spring; A connecting hole is respectively formed on the first balance bar and the second balance bar, and one end of the tension spring is connected to the connecting hole of the first balance bar and the other end is connected to the connecting hole of the second balance bar.

The utility model has the beneficial effects that the shading piece is arranged on the elastic piece of the balance frame assembly, which endows the balance frame assembly with the function of triggering the on-off of the key switch, so that the smooth pressing action is synchronized with the on-off action of the optical path, thereby realizing the synchronization of the smooth pressing and the on-off action of the key switch, improving the accuracy and sensitivity of the on-off action of the key switch, and having long service life.

The above is an overview of the technical scheme of the utility model, and the following is a further explanation of the utility model with the attached drawings and specific embodiments.

### BRIEF DESCRIPTION OF DRAWINGS

FIG. 1 is an exploded view of the utility model;

FIG. 2 is a structural schematic diagram of the utility model;

FIG. 3 is a sectional view of the utility model;

FIG. 4 is a schematic structural diagram of the utility model in which the light-emitting pair tube is arranged at the bottom of the base;

FIG. 5 is a schematic structural diagram of the base in the utility model.

### EMBODIMENT

In order to further explain the technical means and effects adopted by the utility model to achieve the predetermined purpose, the specific implementation of the utility model will be described in detail with the attached drawings and preferred embodiments.

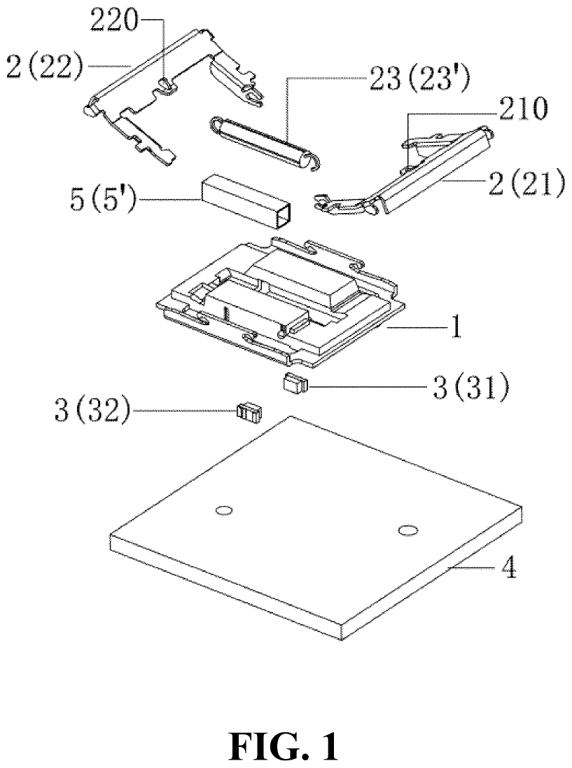

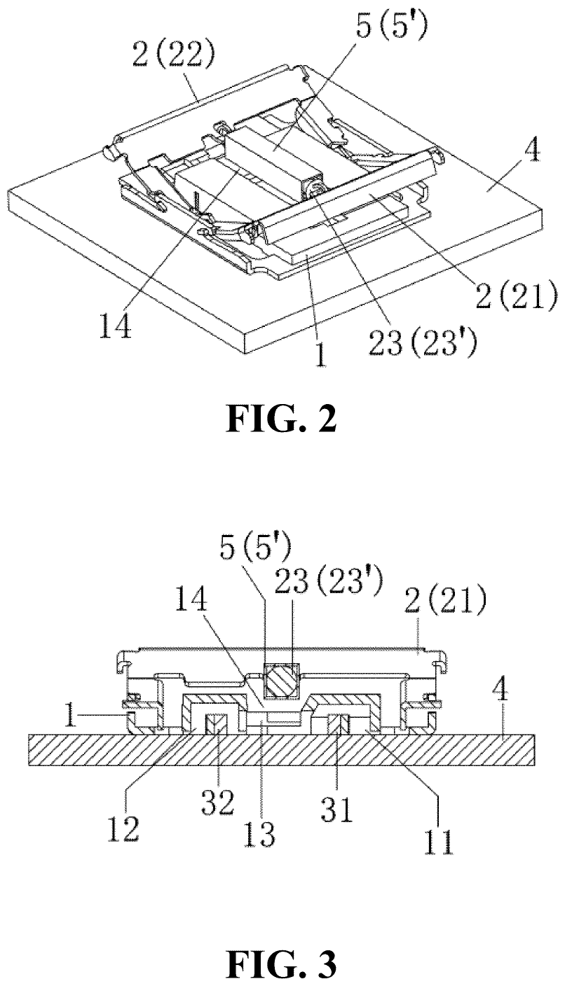

Please refer to FIG. 1 to FIG. 3. An embodiment of the utility model provides an elastic trigger type photoelectric conduction mechanism applied to a key switch, which comprises a base 1, a balance frame assembly 2 arranged on the base 1, and a light emitting diode 3 electrically connected to a PCB board 4.

The balance frame assembly 2 includes a first balance bar 21 rotatably connected to the base 1, a second balance bar 22 rotatably connected to the base 1, and an elastic member 23 connected between the first balance bar 21 and the second balance bar 22. The light-emitting pair tube 3 includes a light-emitting element 31 and a photosensitive element 32 electrically connected to the PCB board 4, and a light shielding member 5 for shielding light between the light-emitting element 31 and the photosensitive element 32 is provided on the elastic member 23.

When the balance frame assembly 2 is forced to move up and down, the balance frame assembly 2 provides balance and stability for the pressing of the key switch, and at the same time, the elastic member 23 that moves up and down synchronously drives the shutter 5 to move up and down, thereby blocking and removing the light between the light-emitting element 31 and the photosensitive element 32, that is, connecting or blocking the light path between the light-emitting element 31 and the photosensitive element 32, so as to trigger the light-emitting tube 3 to be turned on and off, thereby realizing the on and off functions of the key switch. By arranging the shading member 5 on the elastic member 23 of the balance frame assembly 2, the balance frame assembly 2 is endowed with the function of triggering the on-off of the key switch, so that the smooth pressing action is synchronized with the on-off action of the optical path, thereby realizing the synchronization of the smooth pressing and the on-off action of the key switch, improving the accuracy and sensitivity of the on-off action of the key switch, and having a long service life.

Specifically, when the first balance bar 21 and the second balance bar 22 are pressed downwards, the elastic member 23 is elastically deformed and moves downwards, so that the light shielding member 5 moves downwards and enters the optical path between the light emitting element 31 and the light sensitive element 32 to shield the light between the light emitting element 31 and the light sensitive element 32, and this state is set as the key switch on state; When the pressure on the first balance bar 21 and the second balance bar 22 disappears, the first balance bar 21 and the second balance bar 22 are driven to swing up by the elastic restoring force of the elastic piece 23, and the elastic piece 23 moves up, so that the light shielding sleeve 5′moves up and leaves the optical path between the light emitting element 31 and the photosensitive element 32, and the light shielding between the light emitting element 31 and the photosensitive element 32 is eliminated, and this state is set to the key switch off state.

In this embodiment, the shading member 5 is a shading sleeve 5′wrapped around the elastic member 23, and the elastic member 23 is wrapped by the shading sleeve 5′to prevent light leakage and play a role in accurate shading.

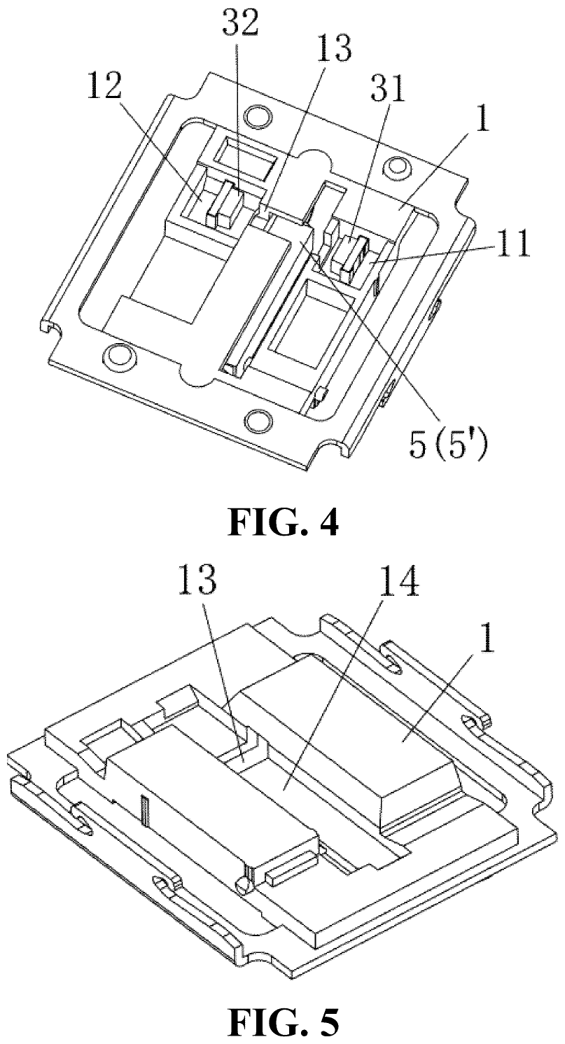

As for the installation of the light-emitting element 31 and the light-sensitive element 32, as shown in FIG. 4, a first accommodating cavity 11 and a second accommodating cavity 12 are respectively formed on the lower end surface of the base 1. The light-emitting element 31 is embedded in the first accommodating cavity 11, and the light-sensitive element 32 is embedded in the second accommodating cavity 12. Meanwhile, as shown in FIG. 5, a light channel 13 is formed on the base 1, which is respectively communicated with the first accommodating cavity 11 and the second accommodating cavity 12. A movable groove 14 is formed on the base 1 for the shutter 5 to move up and down and extend to the light channel 13.

The light-emitting element 31 and the photosensitive element 32 are surrounded by the first accommodating cavity 11 and the second accommodating cavity 12, respectively, so as to prevent the light emitted by the light-emitting element 31 from diverging to other places and prevent the photosensitive element 32 from absorbing light in other directions, so that the light emitted by the light-emitting element 31 is only emitted from the light channel 13 to the photosensitive element 32, and the photosensitive element 32 only receives the light diverging from the light channel 13, thereby improving the accuracy of conducting and disconnecting the light-emitting tube 3.

In this embodiment, the elastic member 23 is a tension spring 23′; Connecting holes (210,220) are respectively formed on the first balance bar 21 and the second balance bar 22, and one end of the tension spring 23′is connected to the connecting hole 210 of the first balance bar 21 and the other end is connected to the connecting hole 220 of the second balance bar 22. Therefore, when the first balance bar 21 and the second balance bar 22 swing up and down under pressure to provide balance and stability, the tension spring 23′can be driven to move up and down synchronously, and the tension spring 23′provides elastic restoring force for pressing and resetting.

When in use, a keycap is installed on the first balance bar 21 and the second balance bar 22. The specific structure of the first balance bar 21 and the second balance bar 22, and the installation mode of the key cap are not the innovation points of this utility model. For the specific structure, please refer to the utility model patent with the patent number of 202121092814.4 and the patent name is “a photoelectric key switch for increasing the pressing feel”, which is not repeated here.

What needs to be explained here is that the elastic trigger photoelectric conduction mechanism applied to the key switch disclosed by this utility model is an improvement on the specific structure, but it is not an innovation of this utility model for the specific control mode. The PCB board, light-emitting element, photosensitive element and other parts involved in this utility model can be common standard parts or parts known to technicians in this field, and their structures, principles and control methods are known to technicians in this field through technical manuals or through conventional experimental methods.

The above is only the preferred embodiment of this utility model, and it does not limit the technical scope of this utility model. Therefore, other structures obtained by adopting the same or similar technical features as the above embodiments of this utility model are within the protection scope of this utility model.

What is claimed is:

1. The invention relates to an elastic piece triggered photoelectric conduction mechanism applied to a key switch, which comprises a base, a balance frame component arranged on the base, and a light-emitting diode electrically connected to a PCB board. Wherein, the balance frame assembly comprises a first balance bar rotatably connected to the base, a second balance bar rotatably connected to the base, and an elastic piece connected between the first balance bar and the second balance bar, and the light-emitting pair tube comprises a light-emitting element and a light-sensitive element electrically connected to the PCB board respectively, and is characterized in that a light-shielding piece for shielding light between the light-emitting element and the light-sensitive element is arranged on the elastic piece.

2. According to claim 1, the elastic element triggered photoelectric conduction mechanism applied to the key switch is characterized in that the shading element is a shading sleeve wrapped around the elastic element.

3. According to claim 1, the elastic element triggered photoelectric conduction mechanism applied to the key switch is characterized in that a first accommodating cavity and a second accommodating cavity are respectively formed on the lower end surface of the base, the light emitting element is embedded in the first accommodating cavity, and the photosensitive element is embedded in the second accommodating cavity.

4. The elastic element-triggered photoelectric conduction mechanism applied to the key switch according to claim 3 is characterized in that a light channel which is respectively communicated with the first accommodating cavity and the second accommodating cavity is formed on the base; A movable groove for the shade to move up and down and extend to the light channel is formed on the base.

5. According to claim 1, the elastic element-triggered photoelectric conduction mechanism applied to the key switch is characterized in that the elastic element is a tension spring; A connecting hole is respectively formed on the first balance bar and the second balance bar, and one end of the tension spring is connected to the connecting hole of the first balance bar and the other end is connected to the connecting hole of the second balance bar.
